(19) United States
(12) Patent Application Publication
(10) Pub. No.: US 2003/0110022 A1
(43) Pub. Date: Jun. 12, 2003

(54) Multimedia-aided verb tense teaching system and method

(76) Inventors: Sayling Wen, Taipei (TW); Zechary Chang, Taipei (TW); Yeats Gu, Beijing (CN)

Correspondence Address: BIRCH STEWART KOLASCH & BIRCH, PO BOX 747, FALLS CHURCH, VA, 22040-0747, US

(21) Appl. No.: 10/005,813

(22) Filed: Dec. 7, 2001

(51) Int. Cl. G06F 17/20

(52) U.S. Cl. 704/1

(57) ABSTRACT

A verb tense teaching system using multimedia and its method are disclosed. The invention runs on a computer executable hardware platform. By integrating multimedia technologies and verb tenses by a computer storage medium, users can more readily learn verb tenses. The invention combines multimedia data and verb tenses data so that users can adjust a time unit to present different multimedia data for learning verb tenses.

### BACKGROUND OF THE INVENTION

1. Field of the Invention

The invention relates to an application of storage media and, in particular, to a verb tense teaching system that is combined with and run by multimedia computer technologies and the corresponding methods.

2. Related Art

The most difficult aspect of learning a foreign language is its grammar rules. Grammar rules are abstract combinations of statements extracted from innumerable examples. They usually have neither fixed rules nor definite right-and-wrong formulations. Thus, one cannot use normal logic concepts to determine grammatical errors. Learners often ask questions such as why a particular sentence cannot be expressed in some other way. The answer is usually because of grammar rules. Each language has its own specific grammar rules.

Taking the most commonly studied language, English, as an example, verb tenses are the most difficult part. Especially for Chinese speakers, the difference in language systems increases the difficulty in learning English. Chinese speakers are not used to different tenses due to time differences. However, this is part of English grammar rules.

Conventional learning methods mostly use books or some abstract explanations in words. Learners are provided with descriptions of various tenses and when to use a particular tense and sentence pattern. This learning style is quite boring and cannot achieve its intended goals. Although some TV programs or teaching videos provide richer pictures or actions, they still cannot provide interactive learning simply because of their own limitations.

### SUMMARY OF THE INVENTION

In light of the foregoing, the invention provides a verb tense teaching system using multimedia and its method. It offers users a bidirectional interactive verb tense teaching system. The system can play multimedia verb tense data for users as time changes require changes in sentence structure.

The disclosed multimedia-aided verb tense teaching system and method includes a language knowledge database, a time unit and a processing unit. The language knowledge database stores tense-related multimedia data, including a grammar rule database for storing verb tense data and tense code data, an animation database for storing corresponding animation data and animation codes, and an animation correspondence table that relates grammar rules and animation data. The time unit manages the correspondence between verb tense data of the language knowledge database and time. The processing unit receives a command given by a user to the time unit. According to the processing result by the time unit, the processing unit reads and plays the corresponding language data and multimedia data from the language knowledge database. Multimedia data for different verb tenses generated according to different times are provided to users so they can learn verb tenses interactively.

### BRIEF DESCRIPTION OF THE DRAWINGS

The invention will become more fully understood from the detailed description given hereinbelow. However, the following description is for purposes of illustration only, and thus is not limitative of the invention, wherein:

FIG. 1 is a schematic functional block diagram of the disclosed multimedia-aided verb tense teaching system;

FIG. 2 is a schematic view of the language knowledge database of the system in FIG. 1;

FIG. 3 is a schematic view of the grammar rule database of the system in FIG. 1;

FIG. 4 is a schematic view of the animation database of the system in FIG. 1;

FIG. 5 is a schematic view showing steps in the disclosed multimedia-aided verb tense teaching method;

FIG. 6 is a list of basic verb tenses in a preferred embodiment of the multimedia-aided verb tense teaching system and its method;

FIG. 7 shows verb tense rule descriptions and succeeding animation relations of the embodiment in FIG. 6; and

FIGS. 8A through 8F are demonstrative screens of the multimedia-aided verb tense teaching system and method.

### DETAILED DESCRIPTION OF THE INVENTION

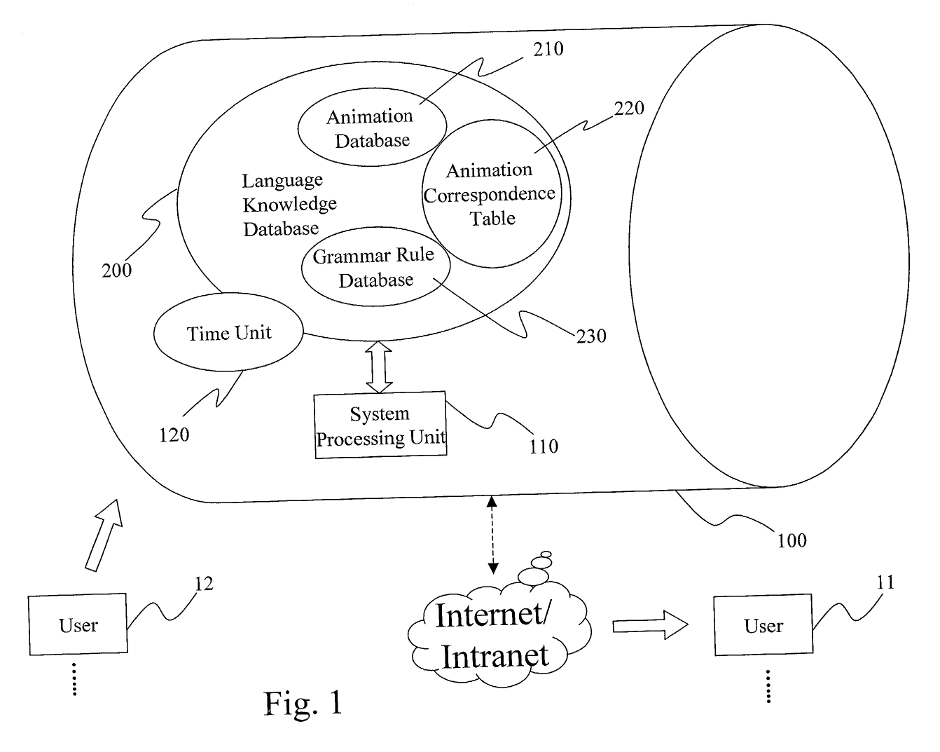

As shown in FIG. 1, the disclosed multimedia-aided verb tense teaching system 100 includes a system processing unit 110, a time unit 120 and a language knowledge database 200. It provides users 11 and 12 an interactive environment for learning verb tenses. As shown in the drawing, user 11 connects to the system 100 via the Internet, while user 12 connects to the system 100 directly.

The language knowledge database 200 stores verb tense related multimedia data, including a grammar rule database 230, an animation database 210, and an animation correspondence table 220. The grammar rule database 230 stores verb tense data and tense code data. The animation database 210 stores corresponding animation data and animation codes. The animation correspondence table 220 relates grammar rules with corresponding animation data.

The users 11 and 12 generate a command by adjusting the time. The command is processed by the time unit 120 and the system processing unit 110. Multimedia data corresponding to the required verb tense are read out from the language knowledge database 200 and played. The multimedia data include animations with texts, sounds, and pictures.

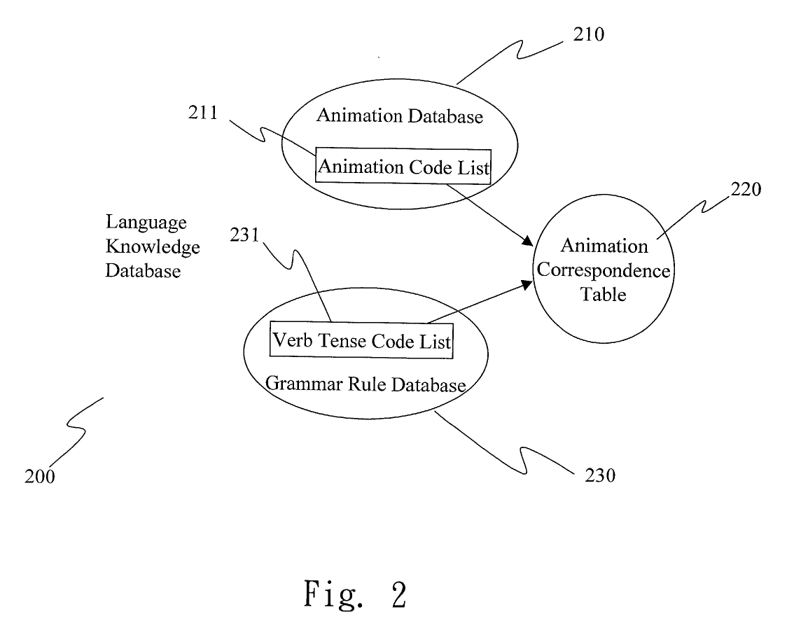

With reference to FIG. 2, the grammar rule database 230 has a verb tense code list 231, storing codes that correspond to tense data recording tense example sentences and descriptions. The animation database 210 also has an animation code list 211, storing codes that correspond to animation data for all verb tenses. The animation correspondence table 220 stores the relations between the two sets of codes, i.e. the correspondence between the codes for the animation data for all verb tenses and the codes for verb tense data recording tense example sentences and descriptions.

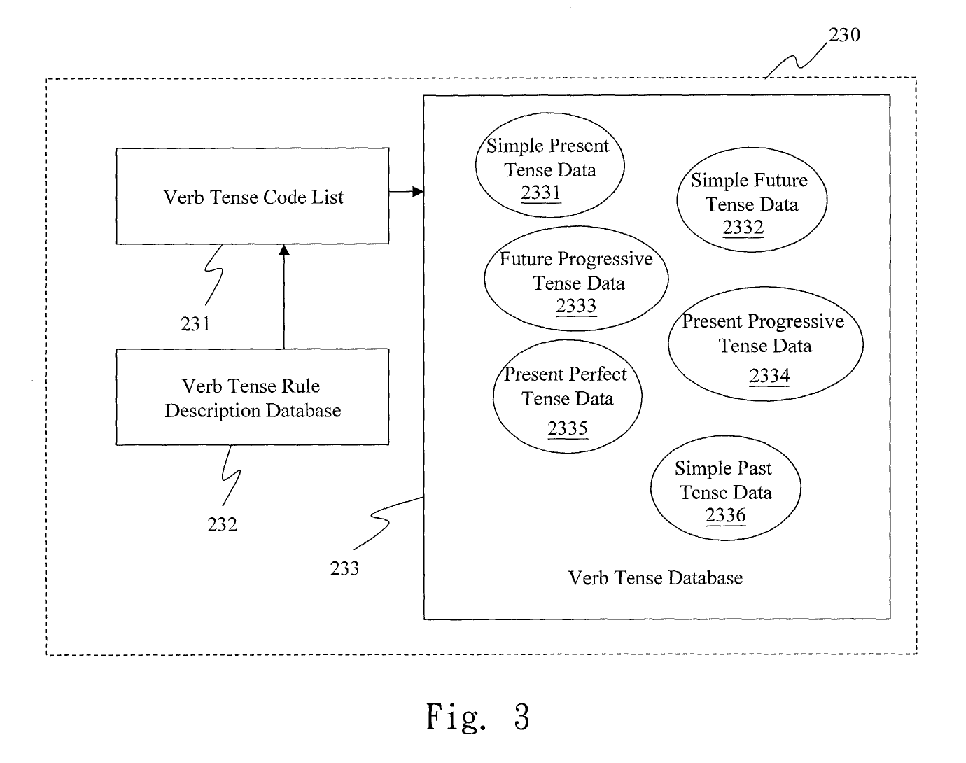

As shown in FIG. 3, the grammar rule database 230 includes a verb tense code list 231, a tense rule description database 232 and a tense database 233. The tense database 233 stores example sentences of all tenses, including simple present tense data 2331, simple future tense data 2332, future progressive tense data 2333, present progressive tense data 2334, present perfect tense data 2335, simple past tense data 2336, and so on. The tense rule description database 232 stores descriptions for all verb tenses, providing users another way to understand tense rules in addition to multimedia data. As described before, the tense code list 231 connects associated multimedia data.

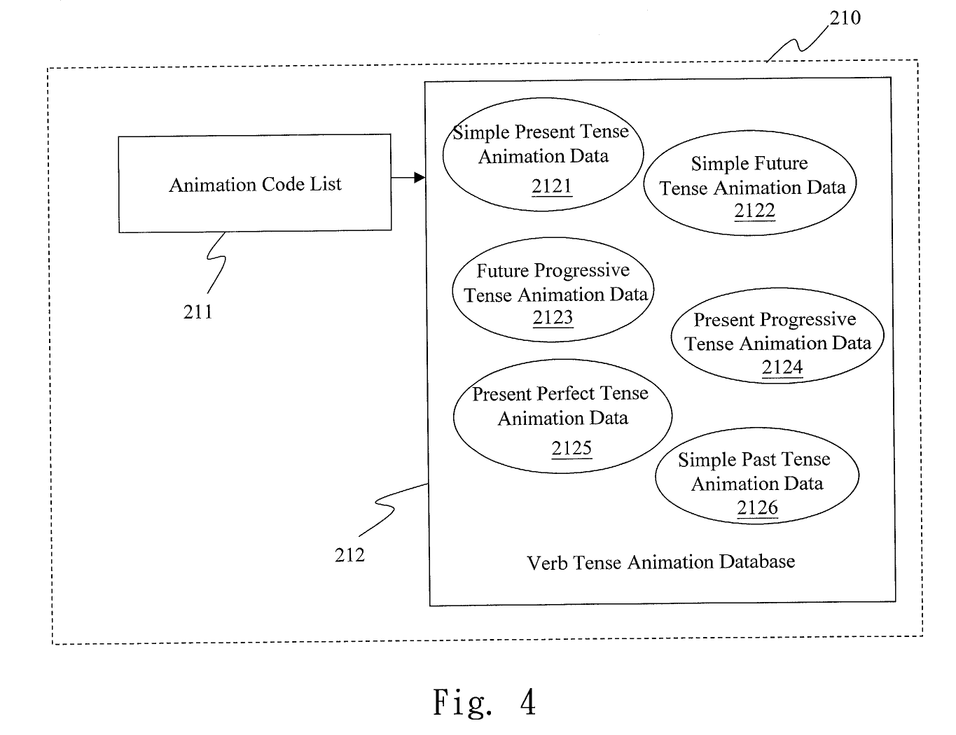

The animation database 210 includes an animation code list 211 and a verb tense animation database 212. As shown in FIG. 4, the verb tense animation database 212 stores multimedia data corresponding to all verb tenses, such as simple present tense animation data 2121, simple future tense animation data 2122, future progressive tense animation data 2123, present progressive tense animation data 2124, present perfect tense animation data 2125, simple past tense animation data 2126, and so on. The animation code list 211 gives codes of animation data for all verb tenses.

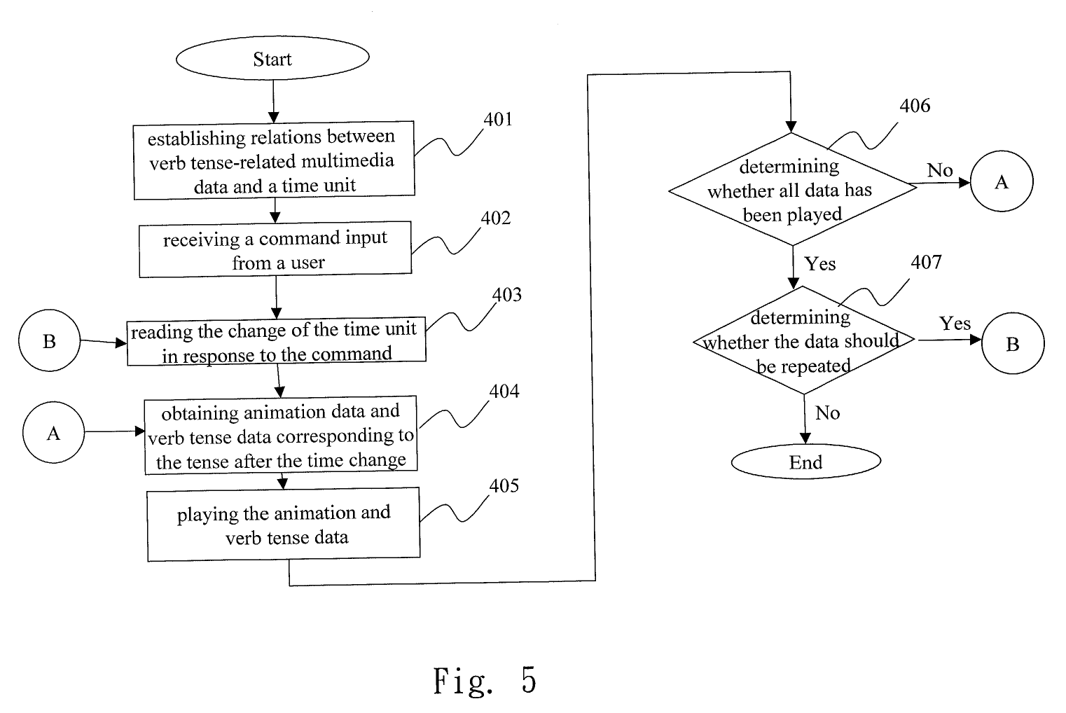

With reference to FIG. 5, the disclosed multimedia-aided verb tense teaching method first establishes animation data, verb tense data, a time unit 120, and the relations between them in step 401. Step 402 receives a command entered by a user, i.e. the change command given by the user on the time unit 120. The time unit 120 can be a clock or a calendar that users can adjust to change the verb tense in the multimedia data. Step 403 reads the change of the time unit 120 in response to the command. Step 404 obtains animation data and verb tense data corresponding to the tense after the time change. Step 405 plays the animation and verb tense data. Step 406 determines whether all data has been played. If they are not finished, then the data are read and played. Otherwise, step 407 determines whether the data should be repeated. If so, then the data are played again.

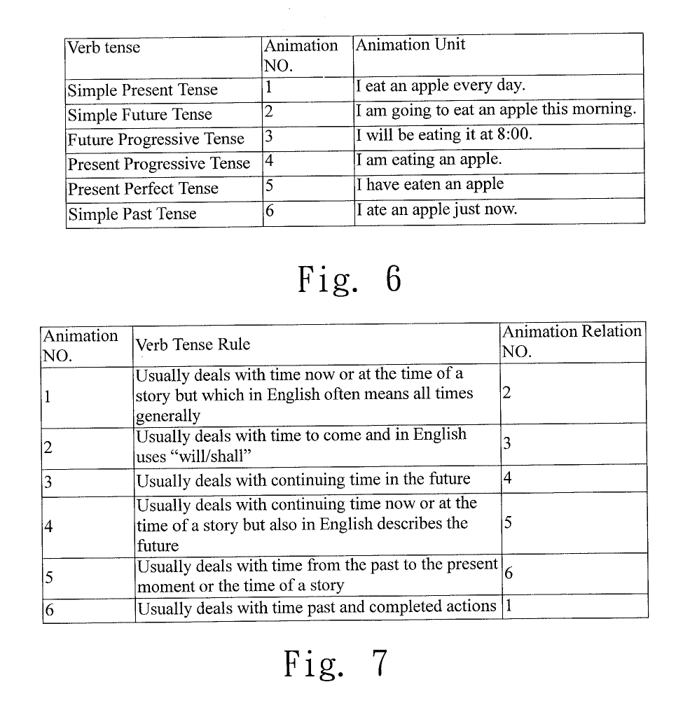

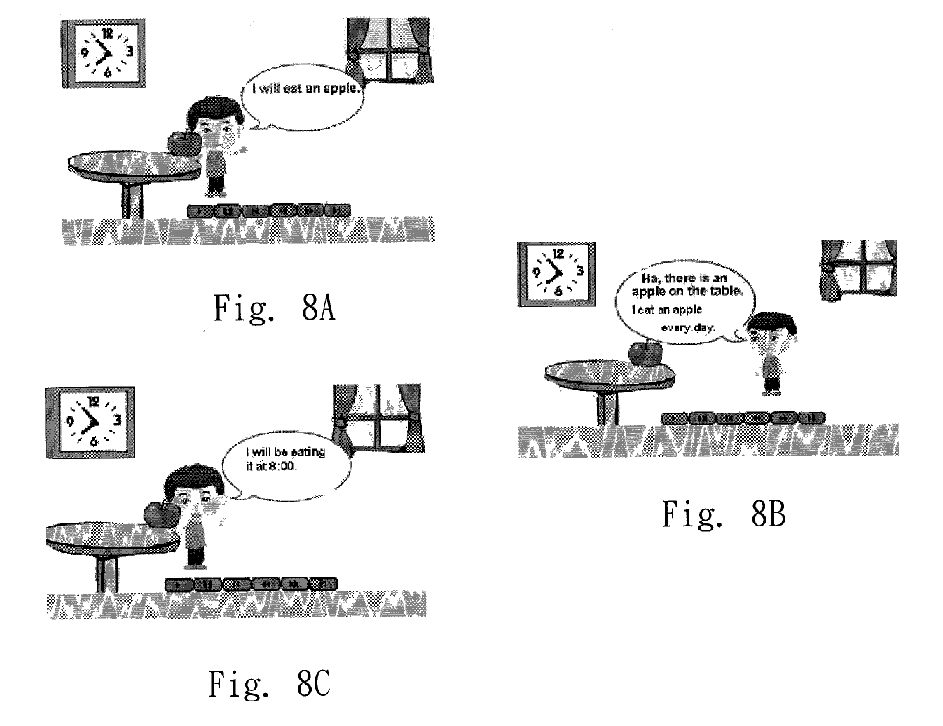

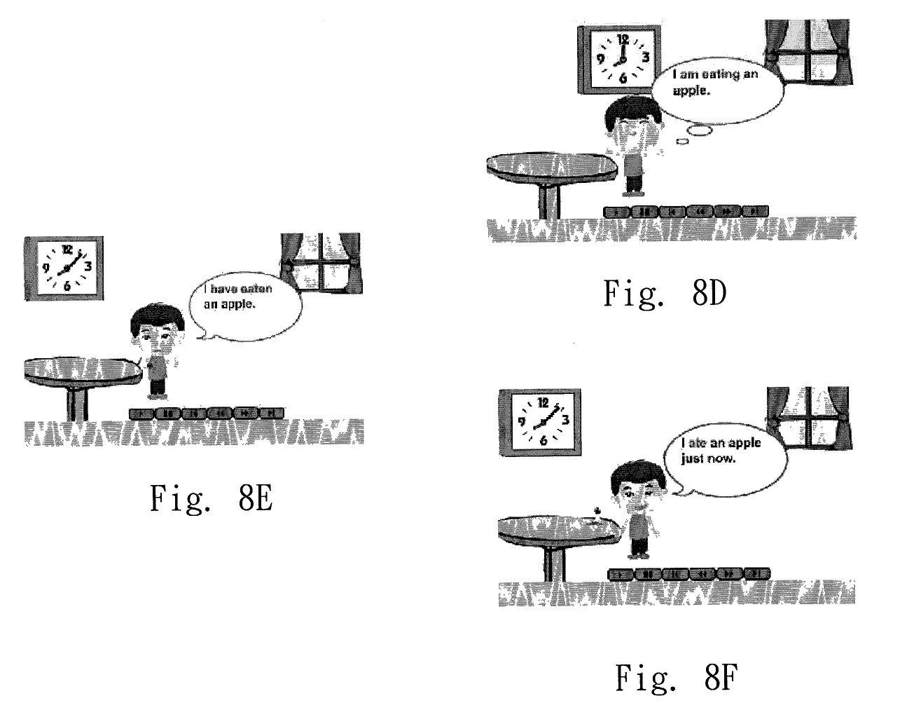

To make the contents of the invention more evident, an embodiment is given below for explanation. As shown in FIG. 6, each piece of verb tense data has corresponding example sentences and animation codes. Each verb tense also has its description and a succeeding relation (see FIG. 7). Actual animations are shown in FIGS. 8A through 8F, which play multimedia data for different verb tenses. Each picture has a clock for the user to adjust to provide animations and example sentences for different verb tenses.

Effects of the Invention

The invention discloses a multimedia-aided verb tense teaching system and method that includes a language knowledge database, a time unit and a processing unit. The language knowledge database stores verb tense-related multimedia data. The time unit stores the correspondence between verb tense data of the language knowledge database and time. The processing unit receives a command given by a user to the time unit. According to the processing result by the time unit, the processing unit reads and plays the corresponding language data and multimedia data from the language knowledge database. The user can adjust the time and multimedia data for different verb tenses are generated for users to learn the tenses interactively.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A multimedia-aided verb tense teaching system applied in a computer executable hardware platform, which comprises:
a language knowledge database for storing verb tense-related multimedia data, including:
a grammar rule database which stores verb tense data and tense codes;
an animation database which stores animation data and animation codes; and
an animation correspondence table, which stores correspondences between entries in the grammar rule database and entries in the animation database;
a time unit for storing correspondences between verb tense data in the language knowledge database and time; and
a processing unit, which receives a time-related command from a user and, according to the processing result from the time unit, reads and plays the corresponding verb data and multimedia data.

2. The system of claim 1, wherein the grammar rule database further comprises:
a tense database, which stores a plurality of tense data;
a tense rule description database, which stores description data corresponding to the tense data; and
a tense code list, which stores codes of the tense data.

3. The system of claim 2, wherein the tense data include simple present tense data, simple future tense data, future progressive tense data, present progressive tense data, present perfect tense data, and simple past tense data.

4. The system of claim 3, wherein the tense rule description data include simple present tense description data, simple future tense description data, future progressive tense description data, present progressive tense description data, present perfect tense description data, and simple past tense description data.

5. The system of claim 2, wherein the tense data are grammar example sentences corresponding to all tenses.

6. The system of claim 2, wherein the codes stored in the tense code list are used for the animation correspondence table to establish correspondences.

7. The system of claim 1, wherein the animation database further comprises:
a tense animation database, which stores a plurality of tense animation data; and
an animation code list, which stores codes corresponding to the tense animation data.

8. The system of claim 7, wherein the tense animation data include simple present tense animation data, simple future tense animation data, future progressive tense animation data, present progressive tense animation data, present perfect tense animation data, and simple past tense animation data.

9. The system of claim 7, wherein the codes stored in the animation code list are used for the animation correspondence table to establish correspondences.

10. The system of claim 1, wherein the user connects to the system via the Internet.

11. The system of claim 1, wherein the user directly connects to the system.

12. The system of claim 1, wherein the verb tense-related multimedia data stored in the language knowledge database include sounds, pictures, and texts.

13. A multimedia-aided verb tense teaching method applied in a computer executable hardware platform, which comprises the steps of:
establishing relations between verb tense-related multimedia data and a time unit;
receiving a command input from a user;
determining time corresponding to the command;
reading multimedia corresponding to the time according to the relations; and
playing the multimedia data.

14. The method of claim 13, wherein the multimedia data include sounds, pictures, and texts.

15. The method of claim 13, wherein the command is a correction the user does to the time unit.

16. The method of claim 13, wherein the user enters the command via the Internet.

17. The method of claim 13, wherein the user enters the command to the time unit directly.
